(19) United States
(12) Patent Application Publication
(10) Pub. No.: US 2013/0136191 A1
(43) Pub. Date: May 30, 2013

(54) IMAGE PROCESSING APPARATUS AND CONTROL METHOD THEREOF

(71) Applicant: Jung-ki KIM, Seoul (KR)

(72) Inventor: Jung-ki KIM, Seoul (KR)

(73) Assignee: SAMSUNG ELECTRONICS CO., LTD., Suwon-si (KR)

(21) Appl. No.: 13/553,406

(22) Filed: Jul. 19, 2012

(30) Foreign Application Priority Data
Nov. 30, 2011 (KR) 10-2011-0126825

(51) Int. Cl. H04N 7/26

(52) U.S. Cl. 375/240.26; 375/E07.189

(57) ABSTRACT

An image processing apparatus and a control method are provided. The image processing apparatus includes a receiver which receives a transport stream from an image source; a buffer which stores the transport stream received by the receiver; a demultiplexer which converts the transport stream stored in the buffer into a video stream and transmits the video stream to a decoder; and a controller which controls the buffer to transmit packets of a transmission section of the transport stream to the demultiplexer when a system reference clock of the image processing apparatus corresponds to a stream reference clock calculated from the transport stream stored in the buffer, and controls the system reference clock to synchronize the system reference clock to the stream reference clock at a time at which the transmitted packets reach the demultiplexer.

### CROSS-REFERENCE TO RELATED APPLICATION

This application claims priority from Korean Patent Application No. 10-2011-0126825, filed on Nov. 30, 2011 in the Korean Intellectual Property Office, the disclosure of which is incorporated herein by reference.

### BACKGROUND

1. Field

Apparatuses and methods consistent with exemplary embodiments relate to processing a digital transport stream to display an image, and more particularly to an image processing apparatus which has an improved structure of adjusting timings at which a transport stream is transmitted between components therein to normally display an image, and a control method thereof.

2. Description of the Related Art

An image processing apparatus is a device which processes signals/data/streams input in various ways from external image sources to display as images. The image processing apparatus presents processed data as images on a display panel, or outputs processed data to a separate display apparatus having a display panel, thereby displaying images on the display apparatus. For example, an image processing apparatus available to general users may be provided as a television (TV) in the former case or as a set-top box in the latter case.

An image processing apparatus may or may not control playing of streams depending on characteristics of image sources providing streams corresponding to images. The former case is when streams are provided to the image processing apparatus from broadcasting equipment of a broadcasting station transmitting streams according to a programming schedule.

Meanwhile, the latter case is when streams are provided to the image processing apparatus from a streaming server in a data packet format through a network, such as video on demand (VOD). Such received streams are buffered in the image processing apparatus and transmitted to a demultiplexer, and then to a decoder so that the streams are processed to be displayed as images.

### SUMMARY

According to an aspect of an exemplary embodiment, there is provided an image processing apparatus including: a receiver which receives a transport stream from an image source; a buffer which stores the transport stream received by the receiver; a demultiplexer which converts the transport stream stored in the buffer into a video stream and transmits the video stream to a decoder; and a controller which controls the buffer to transmit packets of a transmission section of the transport stream to the demultiplexer when a system reference clock of the image processing apparatus corresponds to a stream reference clock calculated from the transport stream stored in the buffer, and controls the system reference clock to synchronize the system reference clock to the stream reference clock at a time at which the transmitted packets reach the demultiplexer.

The controller may calculate a clock value of a chronologically first packet in the transmission section based on the stream reference clock and control the buffer to transmit the packets of the transmission section to the demultiplexer when the system reference clock reaches the calculated clock value.

The controller may calculate a transmission rate of the transport stream based on the stream reference clock and control the buffer to transmit the packets in the transmission section to the demultiplexer at a higher transmission rate than the calculated transmission rate.

The controller may calculate the transmission rate of the transport stream from a packet capacity between two stream reference clocks calculated from the transport stream, and a difference between the two stream reference clocks.

A demultiplexer transmission time, at which the packets reach the demultiplexer from the buffer, may be preset, and the controller may control the buffer to transmit the packets in the transmission section to the demultiplexer when the system reference clock of the image processing apparatus reaches a value obtained by deducting the demultiplexer transmission time from the stream reference clock.

The controller may calculate a clock timing of a data packet section based on a first stream reference clock that precedes the data packet section when a first packet in the transmission section is the data packet and not the stream reference clock, and control the buffer to transmit the packets in the transmission section to the demultiplexer when the system reference clock of the image processing apparatus reaches a value obtained by deducting the demultiplexer transmission time from a sum of the first stream reference clock and the clock timing of the data packet section.

The clock timing of the data packet section may be a value obtained by dividing a capacity range of a packet section between the first stream reference clock and the data packet section by the transmission rate of the transport stream.

The controller may designate a packet from a first reference clock to a packet before a second reference clock following the first reference clock among a plurality of stream reference clocks in the transport stream as the transmission section.

The controller may designate the transmission section according to a transmission time range.

The controller may designate the transmission section according to a preset packet capacity range.

The stream reference clock may be formed corresponding to a system time clock (STC) of the image source when the transport stream is generated in the image source.

According to an aspect of another exemplary embodiment, there is provided a control method of an image processing apparatus, the method including: storing in a buffer a transport stream received from an image source; controlling the buffer to transmit packets of a transmission section of the transport stream stored in the buffer to a demultiplexer when a system reference clock of the image processing apparatus corresponds to a stream reference clock calculated from the transport stream stored in the buffer; and controlling the system reference clock to synchronize the system reference clock to the stream reference clock at a time at which the transmitted packets in the transmission section reach the demultiplexer.

The controlling the buffer to transmit the packets may include calculating a clock value of a chronologically first packet in the transmission section based on the stream reference clock; and controlling the buffer to transmit the chronologically first packet of the transmission section to the demultiplexer when the system reference clock reaches the calculated clock value.

The controlling the buffer to transmit the packets may include calculating a transmission rate of the transport stream based on the stream reference clock; and controlling the buffer to transmit the packets of the transmission section to the demultiplexer at a higher transmission rate than the calculated transmission rate.

The calculating the transmission rate of the transport stream may include calculating the transmission rate of the transport stream from a packet capacity between two stream reference clocks calculated from the transport stream, and a difference between the two stream reference clocks.

A demultiplexer transmission time, at which the packets reach the demultiplexer from the buffer, may be preset, and the controlling the buffer to transmit the packets may include controlling the buffer to transmit the packets of the transmission section to the demultiplexer when the system reference clock of the image processing apparatus reaches a value obtained by deducting the demultiplexer transmission time from the stream reference clock.

The controlling the buffer to transmit the packets may include calculating a clock timing of a data packet section based on a first stream reference clock that precedes the data packet section when a first packet in the transmission section is the data packet and not the stream reference clock; and controlling the buffer to transmit the packets of the transmission section to the demultiplexer when the system reference clock of the image processing apparatus reaches a value obtained by deducting the demultiplexer transmission time from a sum of the first stream reference clock and the clock timing of the data packet section.

The clock timing of the data packet section may be a value obtained by dividing a capacity range of a packet section between the first stream reference clock and the data packet section by the transmission rate of the transport stream.

The controlling the buffer to transmit the packets may include designating a packet from a first reference clock to a packet before a second reference clock following the first reference clock among a plurality of stream reference clocks in the transport stream as the transmission section.

The controlling the buffer to transmit the packets include designating the transmission section according to a preset time range.

The controlling the buffer to transmit the packets may include designating the transmission section according to a preset packet capacity range.

The stream reference clock may be formed corresponding to a system time clock (STC) of the image source when the transport stream is generated in the image source.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 is a block diagram illustrating a configuration of an image processing apparatus according to a first exemplary embodiment;

FIG. 2 illustrates an example of a packet configuration of a transport stream transmitted to the image processing apparatus of FIG. 1;

FIG. 3 is a flowchart illustrating a method of transmitting a transport stream stored in a buffer to a demultiplexer in the image processing apparatus of FIG. 1;

FIG. 4 illustrates an example of a transmission section and a transmission time of a transport stream stored in the buffer in the image processing apparatus of FIG. 1; and

FIG. 5 illustrates an example of a transmission section and a transmission time of a transport stream stored in a buffer in an image processing apparatus according to a second exemplary embodiment.

### DETAILED DESCRIPTION OF EXEMPLARY EMBODIMENTS

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity and conciseness, and like reference numerals refer to like elements throughout.

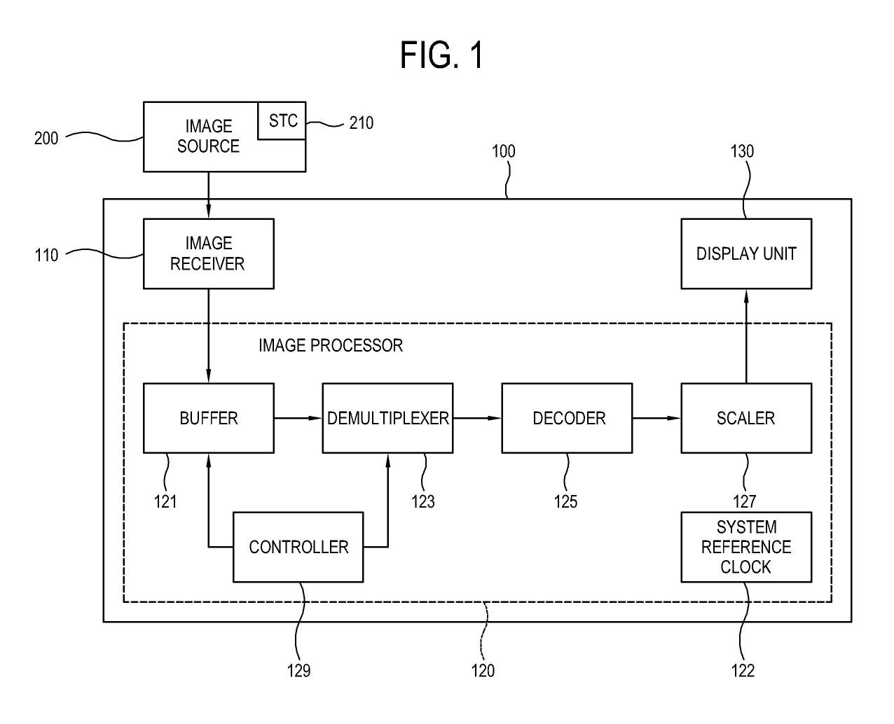

FIG. 1 is a block diagram illustrating a configuration of an image processing apparatus according to a first exemplary embodiment.

As shown in FIG. 1, the image processing apparatus 100 displays an image based on a transport stream received from an image source 200. The present exemplary embodiment illustrates that the image processing apparatus 100 is configured as a TV, which independently displays images. However, the inventive concept is not limited thereto. The image processing apparatus 100 may be configured in other forms, for example, a portable multimedia player or a mobile phone. Also, the image processing apparatus 100 may be configured as a device, for example, a set-top box, which processes and outputs a transport stream to another device so that the transport stream is presented as an image on the other device.

The image source 200 is configured as a streaming server including various image contents. The image source 200 converts image contents into a transport stream in a packet and streamingly transmits the stream to the image processing apparatus 100. Here, the image source 200 generates a transport stream corresponding to a protocol in a network connecting the image source 200 and the image processing apparatus 100 based on a preset image format, such as MPEG-2 or H.264.

The image source 200 includes an independent system time clock (STC) 210 to adapt an operation timing. Not only the image source 200, but also the image processing apparatus 100 includes a system reference clock 122, and the image processing apparatus 100 performs all operations according to the independent system reference clock 122 as well. The STC 210 may also be referred to as a system reference clock. The STC 210 of the image source 200 is separate from and independent of the system reference clock 122 of the image processing apparatus.

The STC 210 is applied when the image source 200 generates a transport stream. Thus, when generating a transport stream, the image source 200 generates STC information at a corresponding time in the transport stream in every preset cycle of the STC.

For example, the image source 200 marks STC information at a time on a section of a transport stream corresponding to the time, at every time when the STC increases by 100, for example 100, 200, 300, and the like. That is, a packet including information, such as that the STC is 100, that the STC is 200, and the like, is disposed in the transport stream in every preset cycle. A packet including STC information may be referred to as a stream reference clock packet or program clock reference (PCR) packet.

That is, a stream reference clock of a transport stream generated in the image source 200 corresponds to an STC of the image source 200. In the following description, a stream reference clock is referred to PCR.

Hereinafter, each component of the image processing apparatus 100 is described.

The image processing apparatus 100 includes an image receiver 110 receiving a transport stream from the image source 200, an image processor 120 processing a transport stream received by the image receiver 110 according to a preset image processing process, and a display unit 130 presenting a transport stream processed by the image processor 120 as an image.

The image receiver 110 is connected to the image source 200 through a preset wired or wireless protocol-based network. The image receiver 110 transmits a transport stream received from the image source 200 to the image processor 120 so that an image based on the transport stream is displayed on the display unit 130.

The present exemplary embodiment illustrates that the image receiver 110 receives a transport stream from an external image source 200. However, the inventive concept is not limited thereto. The image processor 110 may receive a transport stream from a locally connected image play apparatus (not shown) or a memory (not shown) included in the image processing apparatus 100, instead of a network-connected streaming server.

The image processor 120 performs various preset image processing processes on a transport stream received from the image receiver 110. The image processor 120 outputs a processed transport stream to the display panel 130, so that an image based on the transport stream is displayed on the display panel 130.

The image processor 120 may perform, without being limited to, for example, decoding corresponding to an image format of a video stream, de-interlacing to convert an interlaced image signal into a progressive form, scaling to adjust an image signal to a preset resolution, noise reduction to improve image quality, detail enhancement, frame refresh rate conversion, or the like.

The present exemplary embodiment illustrates that the image processor 120 includes a demultiplexer 123, a decoder 125 and a scaler 127. However, the present exemplary embodiment shows only part of components that perform the aforementioned processes in order to concisely and clearly describe the present exemplary embodiment. The image processor 120 may include various components to conduct the above processes in addition to the foregoing components.

The image processor 120 includes a buffer 121 temporarily storing a transport stream received from the image receiver 110, a demultiplexer 123 converting a transport stream temporarily stored in the buffer 121 into a video stream, a decoder 125 decoding a video stream received from the demultiplexer 123 corresponding to a format, a scaler 127 scaling a decoded video stream to a preset resolution, and a controller 129 controlling transmission of a transport stream from the buffer 121 to the demultiplexer 123. These components are part of a plurality of components included in the image processor 120, which are associated with the present exemplary embodiment, and other components are omitted for clarity of description.

The buffer 121 is a memory which temporarily stores data to compensate for a difference between data transmission rates of two components when data is transmitted between the two components which have different data transmission rates. In the present exemplary embodiment, the buffer 121 is installed on a path of a stream between the image receiver 110 and the demultiplexer 123, and a transport stream received by the image receiver 110 is transmitted to the demultiplexer 123 via the buffer 121.

The demultiplexer 123 analyzes and converts a transport stream received from the buffer 121 into a video stream. Here, a transport stream may include video data, audio data and various other data, and in this case the demultiplexer 123 divides the transport stream into a video stream, an audio stream and the other data and transmits the video stream, an audio stream and the other data to the decoder 125, which processes each stream/data.

The decoder 125 decodes a video stream from the demultiplexer 123 into a preset format. Although the present exemplary embodiment illustrates that the decoder 125 processes the video stream, an audio stream and the other data, the decoder 125 may include a video decoder processing video, an audio decoder (not shown) processing sounds and a data processor (not shown) processing other data according to characteristics of streams/data output from the demultiplexer 123. That is, the decoder 125 may be provided as a single component or as separate components.

The controller 129 controls transmission of a transport stream temporarily stored in the buffer 121 to the demultiplexer 123. The controller 129 controls transmission of a designated section of a transport stream in the buffer 121 at a designated time. Further, the controller 129 may control the STC of the image processing apparatus 100 based on the demultiplexer 123. Such functions of the controller 129 will be described in detail.

The display unit 130 displays images based on video streams output from the image processor 120. The display unit 130 may be configured in various display modes using liquid crystals, plasma, light emitting diodes, organic light emitting diodes, a surface conduction electron emitter, a carbon nano-tube, nano-crystals, or the like, without being limited thereto. That is, the display unit 130 is not particularly limited.

The display unit 130 may further include an additional component or components depending on a display mode of the display unit 130. For example, when the display unit 130 is configured in a display mode using liquid crystals, the display unit 130 includes a liquid crystal display panel (not shown), a backlight unit (not shown) providing light to the display panel and a panel driving board (not shown) driving the panel.

With this configuration, a transport stream from the image source 220 is displayed as an image on the image processing apparatus 100 as follows.

A transport stream transmitted from the image source 200 is received by the image receiver 110. The transport stream received by the image receiver 110 is temporarily stored in the buffer 121, and the transport stream in the buffer 121 is transmitted to the demultiplexer 123 by control of the controller 129.

The demultiplexer 12 classifies the transport stream into a video stream, an audio stream and other data and distributes them to the decoder 125. The decoder 125 processes the video stream, the audio stream and the other data properly according to characteristics of the streams/data.

The video stream is transmitted from the decoder 125 to the scaler 127, adjusted by the scaler 127 to a resolution and displayed as an image on the display unit 130.

The respective components of the image processing apparatus 100, that is, the image receiver 110, the buffer 121, the demultiplexer 123, the decoder 125, the scaler 127, and the like, operate according to the STC of the image processing apparatus 100. However, since these components have different processing speeds, a transport stream may not be transmitted at proper timings.

For example, if a transmission rate and a transmission time do not normally function (i.e., become abnormal) when a transport stream is transmitted from the buffer 121 to the demultiplexer 123, the transport stream may be lost in a stage when the demultiplexer 123 processes the transport stream. Such loss may result in an error in a finally displayed image or cause an image and a sound not to correspond to each other. In particular, since the demultiplexer 123 is a component which divides a transport stream into streams/data of different characteristics, it is advantageous to transmit the transport stream from the buffer 121 to the demultiplexer 123 at a proper point of time in view of image quality.

To prevent such loss and to secure transmission quality of a transport stream from the buffer 121 to the demultiplexer 123, the controller 129 according to the present exemplary embodiment operates as follows.

The controller 129 of the image processing apparatus 100 according to the present exemplary embodiment extracts a stream reference clock, PCR, from a transport stream temporarily stored in the buffer 121. When the STC of the image processing apparatus 100 corresponds to the extracted PCR from the transport stream, the controller 129 transmits a packet in a preset section of the transport stream stored in the buffer 121 to the demultiplexer 123.

Here, the controller 129 calculates a transmission rate of the transport stream based on the PCR and transmits the packet in the preset section from the buffer 121 to the demultiplexer 123 at a higher transmission rate than the transmission rate of the transport stream.

Then, the controller 129 synchronizes the STC of the image processing apparatus 100 with the PCR of the transport stream at a time when the packet in the preset section reaches the demultiplexer 123.

Accordingly, the transport stream of the buffer 121 is transmitted to the demultiplexer 123 at a proper time, thereby securing image quality.

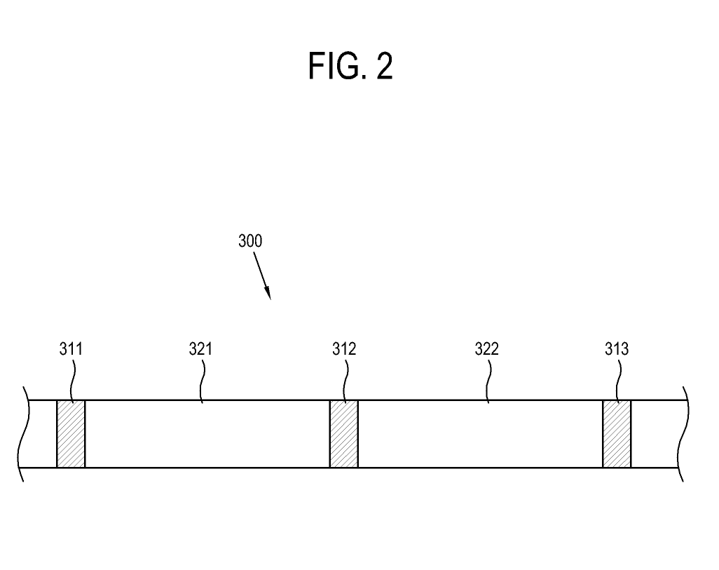

Hereinafter, a configuration of a transport stream 300 stored in the buffer 121 is described with reference to FIG. 2. FIG. 2 illustrates an example of a packet configuration of the transport stream 300.

FIG. 2 shows the transport stream 300 in a time section. The transport stream 300 includes PCR packets 311, 312 and 313 periodically disposed according to time and data packets 321 and 322 disposed among the PCR packets 311, 312 and 313. The data packets 321 and 322 include video data or video, audio and other data.

As described above, the PCR packets 311, 312 and 313 are formed by the image source 200 corresponding to the STC of the image source 200 when the transport stream 300 is generated. Thus, each of the PCR packets 311, 312 and 313 includes STC information about the image source 200 at a time when the corresponding PCR packet 311, 312 or 313 is formed.

For example, if a first PCR packet 311 of FIG. 2 includes a PCR value of 1100, then the PCR value of 1100 denotes that the first PCR packet 311 is formed in the transport stream 300 when the image source 200 has an STC value of 1100.

If the image source 200 forms the PCR packets 311, 312 and 313 at every STC count of 100, a second PCR packet 312 has a PCR value of 1200 and a third PCR packet 313 has a PCR value of 1300. However, one of ordinary skill in the art will understand that the PCR values are only examples, and any type of value that corresponds to the STC of the image source 200 is contemplated.

The controller 129 extracts the PCR packets 311, 312 and 313 from the transport stream 300 stored in the buffer 121 and obtains PCR values from the extracted PCR packets 311, 312 and 313. The controller 129 calculates a transmission rate of the transport stream 300 from these PCR values. A method of calculating a transmission rate based on PCR values may be designated variously, for example, by the following equation.

R=W/(P2−P1) [Equation 1]

Here, R denotes a transmission rate of the transport stream 300, W denotes a packet capacity range from the first PCR packet 311 to the second PCR packet 312, P2 denotes a PCR value of the second PCR packet 312, and P1 denotes a PCR value of the first PCR packet 311.

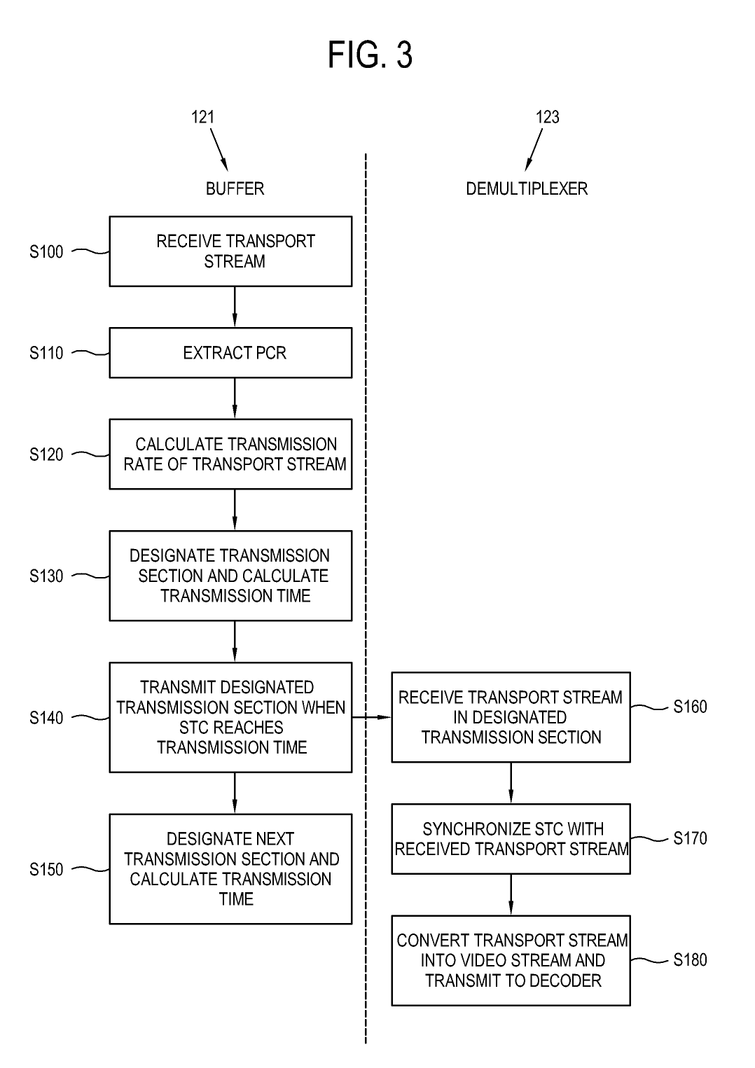

Hereinafter, a method of the controller 129 transmitting such transport stream from the buffer 121 to the demultiplexer 123 is described with reference to FIG. 3. FIG. 3 is a flowchart illustrating a process of the method. Based on a dotted line of FIG. 3, processes on the left are performed by the buffer 121 and processes on the right are performed by the demultiplexer 123.

As shown in FIG. 3, when a transport stream is transmitted to the buffer 121 (S100), the controller 129 extracts a PCR from the transport stream stored in the buffer 121 (S110). The controller 129 calculates a transmission rate of the transport stream based on the extracted PCR (S120). These processes are the same as described with reference to FIG. 2.

The controller 129 designates a transmission section to be transmitted in the transport stream in the buffer 121 and calculates a transmission time at which the designated section is transmitted from the buffer 121 (S130).

Here, a transmission section may be designated variously, without being particularly limited. For example, the transmission section may be a section between two successive PCR packets in the transport stream, that is, a section from a first PCR packet to a packet before a second PCR packet, a section in a preset time range, or a preset packet capacity range. A specific number of the transmission section may be changed variously depending on performance of the image processing apparatus 100, without being particularly limited.

When the transmission section is designated, the controller 129 calculates a transmission time based on a chronologically first packet in the designated transmission section. For example, if a section between two successive PCR packets is determined as a transmission section, the controller 129 determines a PCR value of a first PCR packet in the transmission section as a transmission time.

Alternatively, a demultiplexer transmission time, for which a packet reaches the demultiplexer 123 from the buffer 121, may be preset in the image processing apparatus 100, and the controller 129 may determine a value obtained by deducting the demultiplexer transmission time from the PCR value of the first PCR packet in the transmission packet as a transmission time. The demultiplexer transmission time may be set outside of the image processing apparatus 100, or may be set differently in each image processing apparatus 100.

The controller 129 monitors the STC of the image processing apparatus 100. When the STC reaches the transmission time determined above, the controller 129 transmits a packet stream in the designated transmission section at a preset transmission rate from the buffer 121 to the demultiplexer 123 (S140). Here, the preset transmission rate may be changed variously. For example, the preset transmission rate may be determined to be a higher value than the transmission rate of the transport stream calculated above.

The transmission section is transmitted at a higher transmission rate than the transmission rate of the transport stream, thereby taking time before transmission of a next transmission section. Then, the controller 129 designates a next transmission section to be transmitted in the transport stream stored in the buffer 121 and calculates a transmission time (S150).

Meanwhile, the transmission section of the packet stream transmitted from the buffer 121 at S140 is received by the demultiplexer 123 (S160). The controller 129 synchronizes the STC of the image processing apparatus 100 with the transport stream at a time when the transmission section of the transport stream reaches the demultiplexer 123 (S170).

For example, consider that a first packet in the transmission section transmitted from the buffer 121 to the demultiplexer 123 is a PCR packet and the PCR packet has a PCR value of 1100. In this case, the controller 129 determines a transmission time of the transmission section to be 1100, and transmits the transmission section to the demultiplexer 123 when the running STC reaches 1100.

The controller 129 synchronizes the STC value with the transmission time, 1100, at a time when the transmission section reaches the demultiplexer 123. Accordingly, synchronization of video, audio and other data with each other transmitted from the demultiplexer 123 to the decoder 125 may be secured and loss of the streams/data may be minimized.

If a transmission time from the buffer 121 to the demultiplexer 123 is already applied to the transmission time by presetting the aforementioned demultiplexer transmission time, a range of the STC value adapted by the demultiplexer 123 side narrows as compared with when the demultiplexer transmission time is not preset. Thus, in this case, the controller 129 may easily adjust the STC value.

The demultiplexer 123 converts the received transport stream into a video stream and transmits the video stream to the decoder 125 (S180).

By repetition of the above processes, the image processing apparatus 100 according to the present exemplary embodiment may perform transmission of a transport stream from the buffer 121 to the demultiplexer 123 at a proper timing, thereby securing quality images in the end.

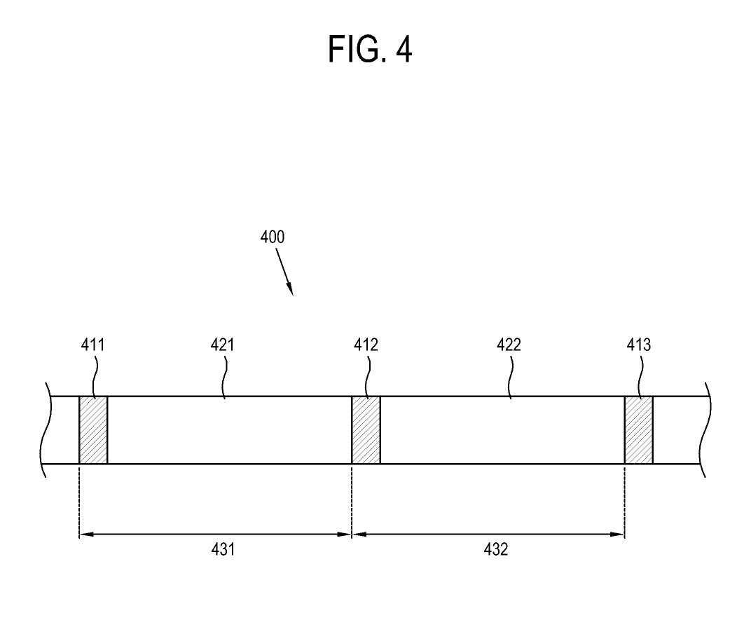

Hereinafter, a method of designating a transmission section and calculating a transmission time corresponding to the transmission section is described in detail with reference to FIG. 4. FIG. 4 illustrates an example of a transmission section and a transmission time of a transport stream 400 stored in the buffer 121.

As shown in FIG. 4, the controller 129 distinguishes PCR packets 411, 412 and 413 and data packets 421 and 422 in the transport stream 400 and extracts PCR values from the respective PCR packets 411, 412 and 413.

The controller 129 designates a section from a first PCR packet 411 to a data packet 421 before a second packet 412 as a transmission section 431. Then, the controller 129 determines a PCR value of a chronologically preceding first packet, the first PCR packet 411, in the transmission section 431 as a transmission time. When a demultiplexer transmission time is preset as described above, the preset demultiplexer transmission time may be applied to determine the transmission time.

When the STC reaches the transmission time, the controller 129 transmits a packet stream of the transmission section 431 from the buffer 121 to the demultiplexer 123.

Then, the controller 129 designated a section from the second PCR packet 412 to a data packet 422 before a third PCR packet 413 as a transmission section 432. The controller 129 determines a PCR value of the second PCR packet 412, which is a chronologically preceding first packet, in the designated transmission section 432 as a transmission time.

The controller 129 transmits the transport stream 400 by repetition of the above processes.

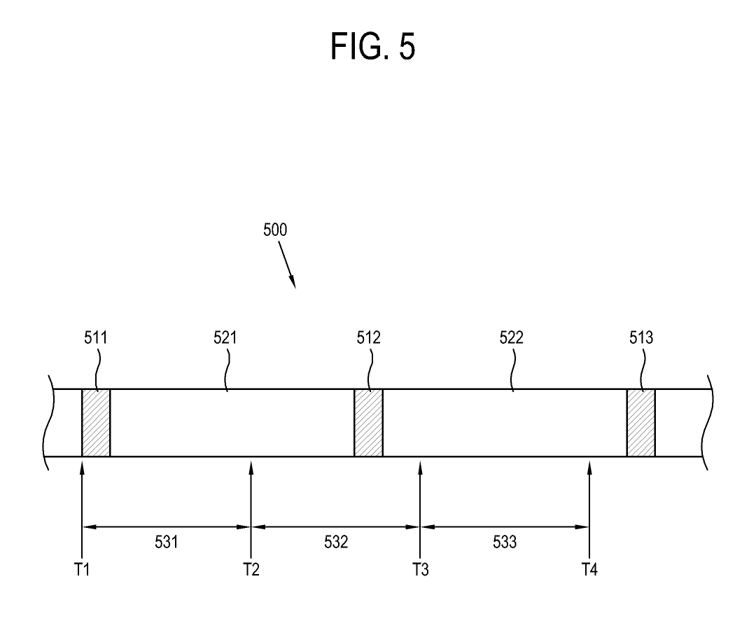

Meanwhile, when a preset time range or packet capacity range is determined as a transmission section, a first packet in the transmission section may not be a PCR packet. In this case, the controller 129 calculates a clock value of a chronologically first packet in the transmission section based on a PCR, and transmits the transmission section to the demultiplexer 123 when the STC reaches the calculated clock value. This case is described in another exemplary embodiment with reference to FIG. 5.

FIG. 5 illustrates an example of a transmission section and a transmission time of a transport stream stored in a buffer of an image processing apparatus according to a second exemplary embodiment. The image processing apparatus 100 according to the present exemplary embodiment has substantially the same configuration as that of the foregoing exemplary embodiment, and thus descriptions thereof are omitted herein.

As shown in FIG. 5, a controller 129 distinguishes PCR packets 511, 512 and 513 and data packets 521 and 522 in the transport stream 500 in the buffer 121 and extracts PCR values from the respective PCR packets 511, 512 and 513.

The controller 129 designates a preset time range from time T1 to time T2 in the transport stream 500 as a transmission section 531. Since a first packet of the transmission section 531 is a first PCR packet 511, the controller 129 determines a transmission time corresponding to a PCR value of the first PCR packet 511 in the same manner as in FIG. 4.

After transmitting the transmission section 531, the controller 129 designates a section from time T2 to time T3 as a transmission section 532. Here, since a first packet of the transmission section 532, that is, a packet corresponding to time T2, is not a PCR packet 511, 512 or 513, a clock value of the packet is calculated based on the preceding first PCR packet 511. The clock value of the packet, that is, a clock value at time T2, may be calculated by Equation 2.

t2=p1+(w1/R) [Equation 2]

Here, t2 denotes a clock value at time T2, p1 denotes a PCR value of the first PCR packet 511, w1 denotes a packet amount from the first PCR packet 511 to the packet corresponding to time T2, and R denotes a transmission rate of the transport stream 500.

If a demultiplexer transmission time, described above, is preset, Equation 2 may be amended as follows.

t2=p1+(w1/R)−D [Equation 3]

Here, D denotes a preset demultiplexer transmission time.

The controller 129 determines t2 thus calculated as a transmission time.

Subsequently, a transmission time at which a transmission section 533 between time T3 and time T4 is transmitted may also be calculated by application of the foregoing processes. The transmission time of the transmission section 533 is calculated by Equation 4.

t3=p2+(w2/R)−D [Equation 4]

Here, t3 denotes a clock value at time T3, p2 denotes a PCR value of the second PCR packet 512, w2 denotes a packet amount from the second PCR packet 512 to a packet corresponding to time T3, R denotes a transmission rate of the transport stream 500, and D denotes a preset demultiplexer transmission time.

That is, the transmission times of the transmission sections 531, 532 and 533 are determined as times when the STC corresponds PCRs of the transport stream 500. Specifically, the transmission times are calculated based on a clock value of a chronologically first packet in the transmission sections 531, 532 and 533.

The clock value of the first packet is calculated based on PCRs, and the controller 129 synchronizes the STC with the clock value of the first packet at times when the transmission sections 531, 532 and 533 reach the demultiplexer 123. Accordingly, the STC on the demultiplexer 123 side may synchronize with the PCRs of the transport stream 500.

As described above, a transmission section and a transmission time of a transport stream in the buffer 121 may be determined.

Although a few exemplary embodiments have been shown and described, it will be appreciated by those skilled in the art that changes may be made in the above-described exemplary embodiments without departing from the principles and spirit of the inventive concept, the scope of which is defined in the appended claims and their equivalents.

What is claimed is:

1. An image processing apparatus comprising:
a receiver which receives a transport stream from an image source;
a buffer which stores the transport stream received by the receiver;
a demultiplexer which converts the transport stream stored in the buffer into a video stream and transmits the video stream to a decoder; and
a controller which controls the buffer to transmit packets of a transmission section of the transport stream to the demultiplexer when a system reference clock of the image processing apparatus corresponds to a stream reference clock calculated from the transport stream stored in the buffer, and controls the system reference clock to synchronize the system reference clock to the stream reference clock at a time at which the transmitted packets reach the demultiplexer.

2. The image processing apparatus of claim 1, wherein the controller calculates a clock value of a chronologically first packet of the transmission section based on the stream reference clock and controls the buffer to transmit the chronologically first packet of the transmission section to the demultiplexer when the system reference clock reaches the calculated clock value.

3. The image processing apparatus of claim 1, wherein the controller calculates a transmission rate of the transport stream based on the stream reference clock and controls the buffer to transmit the packets of the transmission section from the buffer to the demultiplexer at a higher transmission rate than the calculated transmission rate.

4. The image processing apparatus of claim 3, wherein the controller calculates the transmission rate of the transport stream from a packet capacity between two stream reference clocks calculated from the transport stream, and a difference between the two stream reference clocks.

5. The image processing apparatus of claim 1, wherein a demultiplexer transmission time, at which the packets reach the demultiplexer from the buffer, is preset, and the controller controls the buffer to transmit the packets in the transmission section to the demultiplexer when the system reference clock of the image processing apparatus reaches a value obtained by deducting the demultiplexer transmission time from the stream reference clock.

6. The image processing apparatus of claim 5, wherein the controller calculates a clock timing of a data packet section based on a first stream reference clock that precedes the data packet section when a first packet in the preset section is the data packet and not the stream reference clock, and controls the buffer to transmit the packets in the transmission section to the demultiplexer when the system reference clock of the image processing apparatus reaches a value obtained by deducting the demultiplexer transmission time from a sum of the first stream reference clock and the clock timing of the data packet section.

7. The image processing apparatus of claim 6, wherein the clock timing of the data packet section is a value obtained by dividing a capacity range of a packet section between the first stream reference clock and the data packet section, by the transmission rate of the transport stream.

8. The image processing apparatus of claim 1, wherein the controller designates a packet from a first reference clock to a packet before a second reference clock following the first reference clock among a plurality of stream reference clocks in the transport stream as the transmission section.

9. The image processing apparatus of claim 1, wherein the controller designates the transmission section according to a preset time range.

10. The image processing apparatus of claim 1, wherein the controller designates the transmission section according to a preset packet capacity range.

11. The image processing apparatus of claim 1, wherein the stream reference clock is formed corresponding to a system time clock (STC) of the image source when the transport stream is generated in the image source.

12. A control method of an image processing apparatus, the control method comprising:
storing in a buffer a transport stream received from an image source;
controlling the buffer to transmit packets of a transmission section of the transport stream stored in the buffer to a demultiplexer when a system reference clock of the image processing apparatus corresponds to a stream reference clock calculated from the transport stream stored in the buffer; and
controlling the system reference clock to synchronize the system reference clock to the stream reference clock at a time at which the transmitted packets in the transmission section reach the demultiplexer.

13. The control method of claim 12, wherein the controlling the buffer to transmit packets comprises calculating a clock value of a chronologically first packet in the transmission section based on the stream reference clock; and
controlling the buffer to transmit the chronologically first packet of the transmission section to the demultiplexer when the system reference clock reaches the calculated clock value.

14. The control method of claim 12, wherein the controlling the buffer to transmit packets comprises calculating a transmission rate of the transport stream based on the stream reference clock; and
controlling the buffer to transmit the packets of the transmission section from the buffer to the demultiplexer at a higher transmission rate than the calculated transmission rate.

15. The control method of claim 14, wherein the calculating the transmission rate of the transport stream comprises calculating the transmission rate of the transport stream from a packet capacity between two stream reference clocks calculated from the transport stream, and a difference between the two stream reference clocks.

16. The control method of claim 12, wherein a demultiplexer transmission time, at which the packets reach the demultiplexer from the buffer, is preset, and controlling the buffer to transmit the packets comprises controlling the buffer to transmit the packets of the transmission section to the demultiplexer when the system reference clock of the image processing apparatus reaches a value obtained by deducting the demultiplexer transmission time from the stream reference clock.

17. The control method of claim 16, wherein the controlling the buffer to transmit the packets comprises calculating a clock timing of a data packet section based on a first stream reference clock that precedes the data packet section when a first packet in the transmission section is the data packet and not the stream reference clock; and controlling the buffer to transmit the packets of the transmission section to the demultiplexer when the system reference clock of the image processing apparatus reaches a value obtained by deducting the demultiplexer transmission time from a sum of the first stream reference clock and the clock timing of the data packet section.

18. The control method of claim 17, wherein the clock timing of the data packet section is a value obtained by dividing a capacity range of a packet section between the first stream reference clock and the data packet section, by the transmission rate of the transport stream.

19. The control method of claim 12, wherein the controlling the buffer to transmit the packets comprises designating a packet from a first reference clock to a packet before a second reference clock following the first reference clock among a plurality of stream reference clocks in the transport stream as the transmission section.

20. The control method of claim 12, wherein the controlling the buffer to transmit the packets comprises designating the transmission section according to a preset time range.

21. The control method of claim 12, wherein the controlling the buffer to transmit the packets comprises designating the transmission section according to a preset packet capacity range.

22. The control method of claim 12, wherein the stream reference clock is formed corresponding to a system time clock (STC) of the image source when the transport stream is generated in the image source.

23. An image processing apparatus comprising:
a system reference clock;
a buffer which stores a transport stream, the transport stream comprising program clock reference (PCR) packets and data packets;
a demultiplexer which receives packets from the buffer, converts the received packets into a video stream, and transmits the video stream to a decoder; and
a controller which controls the buffer to transmit packets of the transport stream stored in the buffer to the demultiplexer at a timing determined based on the system reference clock and a PCR packet included in the transport stream.

24. The image processing apparatus of claim 23, wherein the controller designates a plurality of transmission sections of the transport stream, controls the buffer to transmit packets of a transmission section of the transport stream to the demultiplexer when the system reference clock corresponds to a stream reference clock calculated from information in a PCR packet of the transmission section, and controls the system reference clock such that the system reference clock is synchronized to the stream reference clock at a time at which the transmitted packets reach the demultiplexer.

25. The image processing apparatus of claim 24, wherein each transmission section includes a PCR packet and a data packet.

26. The image processing apparatus of claim 24, wherein a length of each of the plurality of transmission sections is the same.
